(19) United States
(12) Patent Application Publication
(10) Pub. No.: US 2001/0045933 A1
(43) Pub. Date: Nov. 29, 2001

(54) Liquid crystal optical apparatus

(76) Inventors: Akira Sakaigawa, Yamato (JP); Takaji Numao, Kashiwa (JP)

Correspondence Address: David G. Conlin, Dike, Bronstein, Roberts & Cushman, EDWARDS & ANGELL, LLP, 130 Water Street, Boston, MA, 02109, US

(21) Appl. No.: 09/802,821

(22) Filed: Mar. 9, 2001

(30) Foreign Application Priority Data
Mar. 9, 2000 (JP) 2000-065787

(51) Int. Cl. G09G 3/36

(52) U.S. Cl. 345/98; 345/87

(57) ABSTRACT

A liquid crystal optical apparatus includes a pair of substrates; a liquid crystal layer provided between the pair of substrates and formed of a liquid crystal material in which an aligning direction of liquid crystal molecules changes in accordance with a voltage applied thereto; a plurality of first electrodes provided on one of the pair of substrates; and at least one second electrode provided on the other of the pair of substrates. A frame period for applying a signal to the liquid crystal layer includes a first period in which a voltage is applied to the at least one second electrode, and a write signal for writing information to the liquid crystal layer is applied to one of the plurality of first electrodes, and a second period in which a voltage is applied to the at least one second electrode, and a reset signal for deleting the information written in the liquid crystal layer in the first period is applied to the one of the plurality of first electrodes.

### BACKGROUND OF THE INVENTION

1. FIELD OF THE INVENTION:

The present invention relates to a liquid crystal optical apparatus usable for, for example, a display apparatus, an optical shutter for a laser printer head, and an optical modulation device. Specifically, the present invention relates to a liquid crystal optical apparatus using (i) a liquid crystal material, in which the aligning direction of liquid crystal molecules changes in accordance with the voltage applied thereto, (ii) a liquid crystal material having spontaneous polarization, or (iii) a smectic liquid crystal material.

2. DESCRIPTION OF THE RELATED ART:

In 1980, N. A. Clark and S. T. Lagerwall proposed a liquid crystal display apparatus using a chiral smectic liquid crystal material. Unlike conventional nematic liquid crystal devices using a field effect, which utilizes dielectric anisotropy of liquid crystal molecules, the chiral smectic liquid crystal display apparatus uses a rotational force for aligning the polarity of the chiral smectic liquid crystal molecules obtained by spontaneous polarization and the polarity of the electric field. The chiral smectic liquid crystal display apparatus has a high response; i.e., the time period required for driving pixel electrodes in a switching manner is 1/1000 or less of that of the nematic liquid crystal display apparatuses. Such a high response is obtained by a stronger interaction of the spontaneous polarization of the liquid crystal molecules and the electric field. The high response realizes a high-speed display. Thus, the chiral smectic liquid crystal optical apparatus is expected to be applied to a liquid crystal display apparatus capable of displaying moving pictures.

As a result of many studies, various display modes have been proposed for the chiral smectic liquid crystal material. These display modes include, for example, AFLC (antiferroelectric liquid crystal), TLAFLC (threshold-less antiferroelectric liquid crystal), DHF (distorted helical ferroelectric liquid crystal), and monostable ferroelectric liquid crystal. These display modes do not have a bistable memory function which is inherent to ferroelectric liquid crystal materials, but can realize an analog gray scale display when combined with an active element such as a TFT (thin film transistor). Thus, these display modes are expected to be applied to a liquid crystal display apparatus capable of displaying full-color moving pictures.

A liquid crystal optical apparatus generally needs to be driven by a polarity inversion driving, by which AC waveforms having opposite polarities are alternately applied. This driving is performed in order to match the amount of positive and negative charges in the liquid crystal layer, so as to alleviate the phenomenon that a part of the previous image remains in the next image, which is caused by the localization of impurity ions, or to reduce the influence of the previous display state (hysteresis).

In the case of the nematic liquid crystal material, AC waveforms can be applied with the polarity being inverted at an appropriate cycle, since the amount of light transmitted through the liquid crystal material is the same when the polarity is positive and when the polarity is negative.

In the case of the smectic liquid crystal material, a driving method referred to as a reset driving or a blanking driving needs to be used. The reason for this is that even when the value of the applied voltage is the same, the alignment state of the molecules varies in accordance with the polarity of the applied voltage, and thus the amount of light transmitted through the liquid crystal layer is different when the polarity is positive from when the polarity is negative. According to this driving method, one frame includes a period in which the alignment state of the liquid crystal molecules is reset and a period in which video information is written in the liquid crystal layer. By adjusting the polarization axes of polarizing plates to provide the darkest display in the reset state, the amount of light transmission corresponding to the video information written in the writing period is obtained.

For example, Japanese Patent No. 2677593 discloses a technology for applying a blanking signal immediately before applying a write signal to reset the alignment state of the liquid crystal molecules to the darkest or brightest display state, and then applying the write signal to obtain an amount of light transmission corresponding to the video signal.

Japanese Patent No. 2681528 discloses a technology for alternately applying a write signal and a non-display signal for uniform signal application periods and uniform inter-signal periods so as to prevent a luminance decay from occurring when the bright state is continued.

The technology disclosed in Japanese Patent No. 2677593 (i.e., the technology of once resetting (i.e., blanking) the alignment state of the liquid crystal molecules before writing video information) is the only manner of driving disclosed so far for the smectic liquid crystal display apparatuses. A possible reason is that resetting is first conceived since the smectic liquid crystal material is easily put into a bistable state. However, such a technology has the following problem.

According to this technology, a signal (reset signal) for resetting the alignment state of the liquid crystal molecules always has a voltage which is sufficiently high to reset the alignment state of the liquid crystal molecules in all pixel regions in the liquid crystal layer. (The pixel regions in the liquid crystal layer correspond to pixels.) Accordingly, the reset signal needs to have a such voltage, regardless of the level of the voltage of the write signal.

The voltage of a write signal variously changes in accordance with the video signal. Therefore, the positive and negative charges are unbalanced in a plurality of pixel regions among all the pixel regions, which causes a part of the previous image to unnecessarily remain, or causes a switching defect. This is not practically preferable.

In order to avoid this problem, the reset signal can be simply set to have the same level of voltage as that of the write signal. This causes the following problem.

When, for example, a write signal in one frame has a low voltage, the reset signal also needs to have a low voltage. By the technology disclosed in Japanese Patent No. 2677593, there is a possibility that the alignment state of the liquid crystal molecules is not sufficiently reset. Especially when the alignment state is switched to the bright state almost completely in the previous frame, the write signal has a high voltage. Accordingly, when the subsequent reset signal has a low voltage, the alignment state is not reset and thus the amount of light transmission corresponding to the write signal is not obtained.

Japanese Patent No. 2681528 describes that the non-display signal preferably is 0 V or has a polarity opposite to that of the write signal. Japanese Patent No. 2681528, which has an objective of preventing a luminance decay from occurring when the bright state is continued, once reduces the voltage of the electrode to the ground level or applies the opposite electric field, in order to release the charge of a passivation film.

When the non-display signal is 0 V, the alignment state cannot be sufficiently reset and thus occur the unbalanced positive and negative charges and other problems as can be appreciated from the above description. When the non-display signal has a polarity opposite to that of the write signal, mere application of a non-display signal having the same level of voltage as that of the write signal results in a problem. Accordingly, the technology disclosed in Japanese Patent No. 2681528 does not sufficiently reset the alignment state in the previous frame while maintaining the positive and negative charges well-balanced.

### SUMMARY OF THE INVENTION

The present invention is effective, for example, to a liquid crystal apparatus using a smectic liquid crystal material or a liquid crystal material having spontaneous polarization.

A liquid crystal optical apparatus according to the present invention includes a pair of substrates; a liquid crystal layer provided between the pair of substrates and formed of a liquid crystal material in which an aligning direction of liquid crystal molecules changes in accordance with a voltage applied thereto; a plurality of first electrodes provided on one of the pair of substrates; and at least one second electrode provided on the other of the pair of substrates. A frame period for applying a signal to the liquid crystal layer includes a first period in which a voltage is applied to the at least one second electrode, and a write signal for writing information to the liquid crystal layer is applied to one of the plurality of first electrodes, and a second period in which a voltage is applied to the at least one second electrode, and a reset signal for deleting the information written in the liquid crystal layer in the first period is applied to the one of the plurality of first electrodes.

As a result of discussions described in the section of the “embodiments” below, the present inventors found the following: in a liquid crystal optical apparatus using a liquid crystal material in which an aligning direction of liquid crystal molecules changes in accordance with a voltage applied thereto, it is more preferable to apply a voltage for writing information to a liquid crystal layer in one frame and then apply a voltage for deleting the information to the liquid crystal layer in the same frame, than to apply a voltage for deleting information to the liquid crystal layer in one frame and then apply a voltage for writing information to the liquid crystal layer in the same frame.

In one embodiment of the invention, a voltage of the reset signal has a polarity which is opposite to a polarity of a voltage of the write signal.

In one embodiment of the invention, the reset signal has a peak value which is substantially equal to a peak value of the write signal.

In one embodiment of the invention, a product of a peak value of the write signal and an application period of the write signal is substantially equal to a product of a peak value of the reset signal and an application period of the reset signal.

In one embodiment of the invention, the liquid crystal material having spontaneous polarization.

In one embodiment of the invention, the liquid crystal material is a smectic liquid crystal material.

The present invention is effective for any liquid crystal optical apparatus (especially, a liquid crystal display apparatus) using a liquid crystal material in which an aligning direction of liquid crystal molecules changes in accordance with a voltage applied thereto, not only for a smectic liquid crystal using a smectic liquid crystal material. The present invention is especially effective for a liquid crystal optical apparatus using a smectic liquid crystal material or a liquid crystal having spontaneous polarization.

In one embodiment of the invention, when no voltage is applied to the liquid crystal layer, the liquid crystal molecules of the smectic liquid crystal material are aligned so as to provide a darkest display.

In one embodiment of the invention, when no voltage is applied to the liquid crystal layer, the liquid crystal molecules of the liquid crystal material are in one stable state; and when a voltage is applied to the liquid crystal layer, the liquid crystal molecules are put into another state in accordance with a polarity and a value of the voltage.

In one embodiment of the invention, the liquid crystal material has a bistable state.

In one embodiment of the invention, at least one of the plurality of first electrodes is a pixel electrode. The pixel electrode is connected to an active element corresponding thereto. The active element is connected to a source electrode and a gate electrode which substantially cross each other, and the active element is provided in the vicinity of an intersection of the source electrode and the gate electrode.

Thus, the invention described herein makes possible the advantages of providing a liquid crystal optical apparatus for sufficiently resetting the alignment state of liquid crystal molecules in the previous frame while maintaining the positive and negative charges well-balanced so as to provide a high quality display with no image in the previous frame remaining.

These and other advantages of the present invention will become apparent to those skilled in the art upon reading and understanding the following detailed description with reference to the accompanying figures.

### BRIEF DESCRIPTION OF THE DRAWINGS

FIG. 1 is a cross-sectional view illustrating a fundamental structure of a liquid crystal optical apparatus of an active matrix driving system according to the present invention;

FIG. 2 is an equivalent circuit diagram of one of two substrates of the liquid crystal optical apparatus shown in FIG. 1;

FIG. 3 is a waveform diagram illustrating waveforms of a voltage applied to one gate electrode, a voltage applied to one source electrode, a voltage applied to one pixel electrode, and a transmittance of a corresponding pixel region in the liquid crystal optical apparatus shown in FIG. 1;

FIG. 4 is a view illustrating the positional relationship between liquid crystal molecules and the polarizing plates of the liquid crystal optical apparatus shown in FIG. 1;

FIG. 5 is a waveform diagram illustrating waveforms of a voltage applied to one gate electrode, a voltage applied to one source electrode, and a transmittance of a corresponding pixel region in a liquid crystal optical apparatus according to the present invention used for measurement;

FIG. 6 is a waveform diagram illustrating waveforms of a voltage applied to one gate electrode, a voltage applied to one source electrode, and a transmittance of a corresponding pixel region in a liquid crystal optical apparatus as a comparative example;

FIG. 7 is a view illustrating the positional relationship between liquid crystal molecules having a bistable state and the polarizing plates of a liquid crystal optical apparatus according to the present invention; and

FIG. 8 is a partially cut-away isometric view of a liquid crystal optical apparatus of a duty driving method according to the present invention.

### DESCRIPTION OF THE PREFERRED EMBODIMENTS

Hereinafter, the present invention will be described by way of illustrative examples with reference to the accompanying drawings.

In the following examples, a smectic liquid crystal material is used as a specific liquid crystal material, in which the aligning direction of the liquid crystal molecules varies in accordance with the applied voltage. The present invention is applicable to any liquid crystal material, in which the aligning direction of the liquid crystal molecules varies in accordance with the applied voltage.

### EXAMPLE

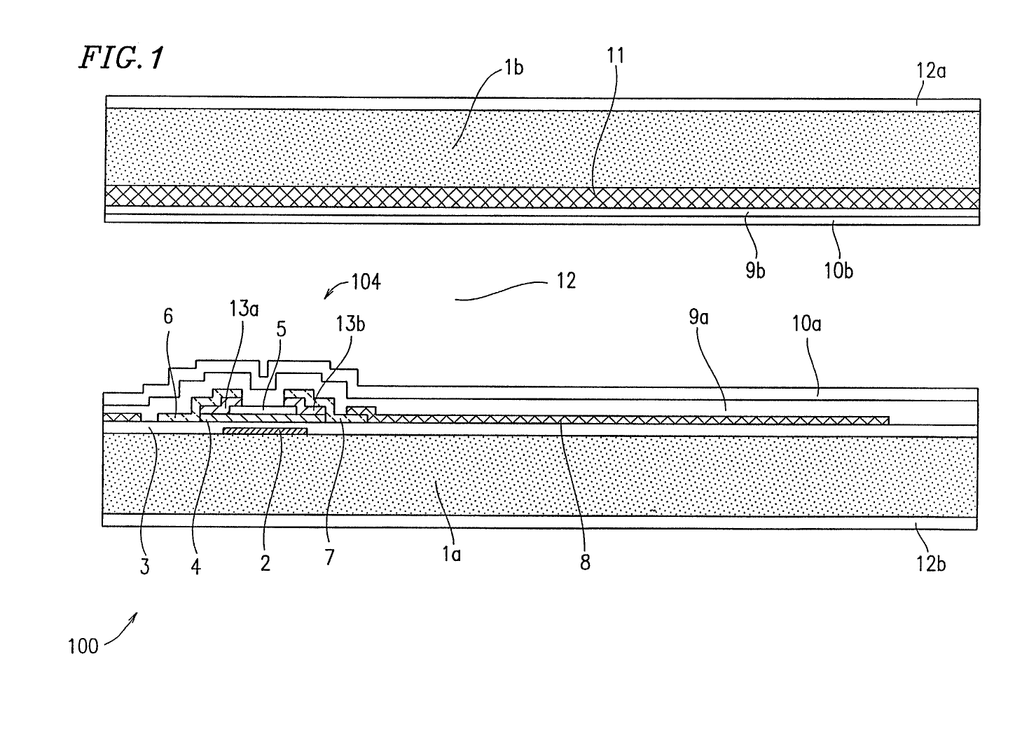

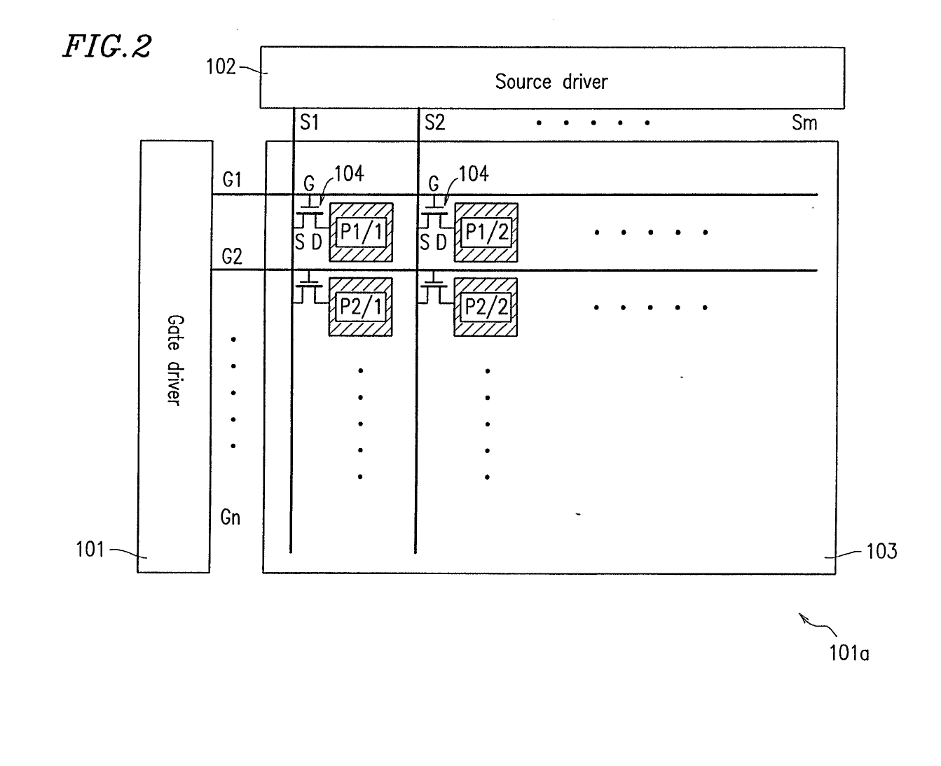

FIG. 1 is a cross-sectional view illustrating one pixel region of a liquid crystal optical apparatus 100 of an active matrix driving system according to one example of the present invention. FIG. 2 is an equivalent circuit diagram of one of two substrates la of the liquid crystal optical apparatus 100 shown in FIG. 1.

As shown in FIG. 1, the liquid crystal optical apparatus 100 includes a pair of substrates 1a and 1b which are provided to face each other, and a smectic liquid crystal layer 12 interposed between the substrates 1a and 1b. As shown in FIG. 2, one of the substrates 1a includes a gate driver 101, a source driver 102, and a display section 103. The gate driver 101 is connected to n gate electrodes (scanning electrodes) Gl through Gn, and the source driver 102 is connected to m source electrodes (signal electrodes) Sl through Sm. The gate electrodes Gl through Gn and the source electrodes Sl through Sm are provided so as to cross each other in the display section 103. TFTs 104 as active elements are respectively provided in the vicinity of intersections of the gate electrodes Gl through Gn and the source electrodes Sl through Sm. A gate G (indicated with reference numeral 2 in FIG. 1) of each TFT 104 is connected to the corresponding gate electrode, and a source S (indicated with reference numeral 6 in FIG. 1) of each TFT 104 is connected to the corresponding source electrode. A drain D (indicated with reference numeral 7 in FIG. 1) of each TFT 104 is connected to the corresponding pixel electrode P1/1, P2/1, . . . P1/2, P2/2 (indicated with reference numeral 8 in FIG. 1). The gate electrode Gl is connected to each of the pixel electrodes P1/1, P1/2, . . . P1/m through the gate G of the corresponding TFT 104, and the gate electrode G2 is connected to each of the pixel electrodes P2/1, P2/2, . . . P2/m through the gate G of the corresponding TFT 104.

As shown in FIG. 1, the TFT 104 includes an a-Si semiconductor layer 4 provided on the gate 2 so as to overlap the gate 2 with a gate insulating layer 3 being interposed therebetween. A gate insulating layer 5 is provided on a central area of the a-Si semiconductor layer 4. n+a-Si layers 13a and 13b are provided respectively so as to cover both of two ends of the a-Si semiconductor layer 4 and the gate insulating layer 5. On the n+a-Si layer 13a, the source 6 is provided. On the n+a-Si layer 13b, the drain 7 is provided. The drain 7 is connected to the pixel electrode 8. The gate insulating layer 5, the source 6, the drain 7, and the pixel electrode 8 are covered with an insulating layer 9a. An alignment layer 10a is provided on the insulating layer 9a.

On the other substrate 1b, a common electrode 11, an insulating layer 9b and an alignment layer 10b are sequentially provided in this order.

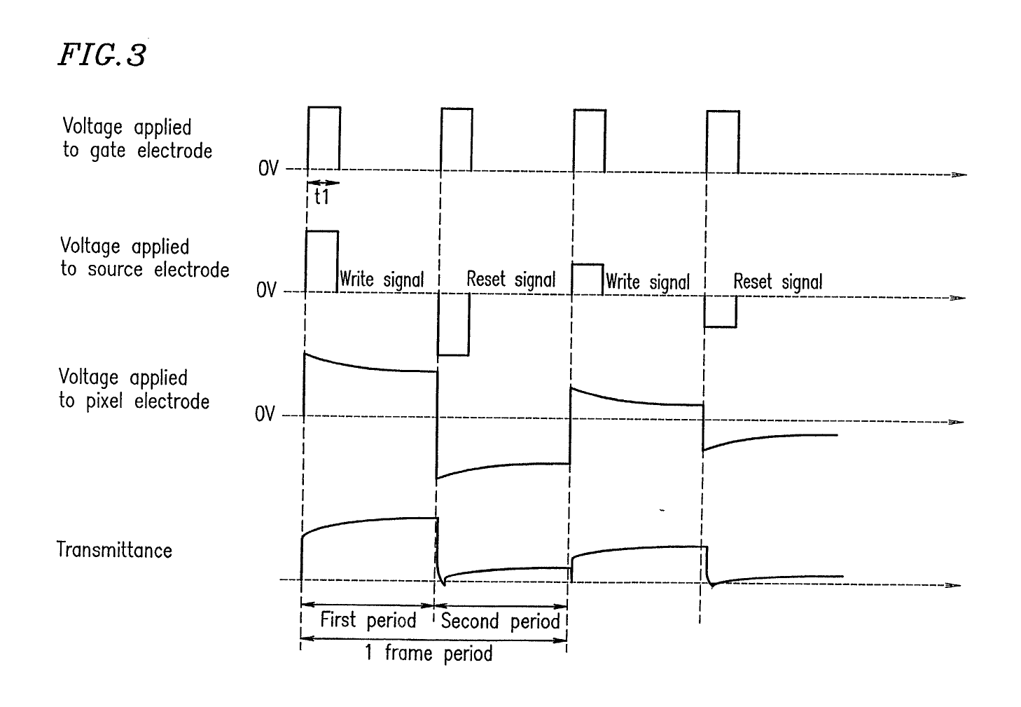

The liquid crystal optical apparatus 100 further includes polarizing plates 12a and 12b on surfaces of the substrates 1a and 1b which are opposite to the smectic liquid crystal layer 12. (In this specification, either one of the polarizing plates 12a and 12b acts as a polarizer and the other polarizing plate acts as an analyzer.) FIG. 3 is a waveform diagram illustrating waveforms of a voltage applied to one gate (or scanning) electrode Gl (FIG. 2), a voltage applied to one source (or signal) electrode Sl, an effective voltage applied to one pixel electrode P1/1, and an optical response (i.e., change in transmittance) of a corresponding pixel region in the smectic liquid crystal layer 12 (FIG. 1).

According to the driving method in this example, one frame includes a first period and a second period; i.e., one frame is the period from the start of scanning of the first period until the end of the scanning of the second period.

First, during time period tl of the first period of a first frame, a signal is applied by the gate electrode Gl to turn on TFTs 104 connected to the gate electrode Gl. In synchronization therewith, a write signal (or state-setting signal) corresponding to a video signal is applied to the pixel electrodes P1/1, P1/2, . . . P1/m each connected to the gate electrode Gl through the gate G of the corresponding TFT 104 by the source electrodes Sl through Sm.

Although not shown in FIG. 3 for the sake of simplicity, during time period t2 following time period tl of the first period of the first frame, a signal is applied by the gate electrode G2 to turn on TFTs 104 connected to the gate electrode G2, and in synchronization therewith, a write signal corresponding to a video signal is applied to the pixel electrodes P2/1, P2/2, . . . P2/m each connected to the gate electrode G2 through the gate G of the corresponding TFT 104 by the source electrodes Sl through Sm. In the same manner, TFTs 104 connected to each of the corresponding to the gate electrodes G3 through Gn are turned on, and a write signal is applied to the corresponding pixel electrodes by the source electrodes Sl through Sm.

After a signal is applied by all the gate electrodes Gl through Gn, during time period tl of the second period of the first frame, a signal is applied by the gate electrode Gl to turn on TFTs 104 connected to the gate electrode Gl. In synchronization therewith, a reset signal is applied to the pixel electrodes P1/1, P1/2, . . . P1/m each connected to the gate electrode Gl through the gate G of the corresponding TFT 104 by the source electrodes Sl through Sm.

Although not shown in FIG. 3 for the sake of simplicity, during time period t2 following time period tl of the second period of the first frame, a signal is applied by the gate electrode G2 to turn on TFTs 104 connected to the gate electrode G2, and in synchronization therewith, a reset signal is applied to the pixel electrodes P2/1, P2/2, . . . P2/m each connected to the gate electrode G2 through the gate G of the corresponding TFT 104 by the source electrodes Sl through Sm. In the same manner, TFTs 104 connected to each of the corresponding to the gate electrodes G3 through Gn are turned on, and a reset signal is applied to the corresponding pixel electrodes by the source electrodes Sl through Sm. Here, the common electrode 11 is supplied with a voltage.

As shown in FIG. 3, the transmittance in accordance with the voltage of the write signal is obtained in the first period of each frame, and the transmittance in accordance with the voltage of the reset signal is obtained in the second period of each frame.

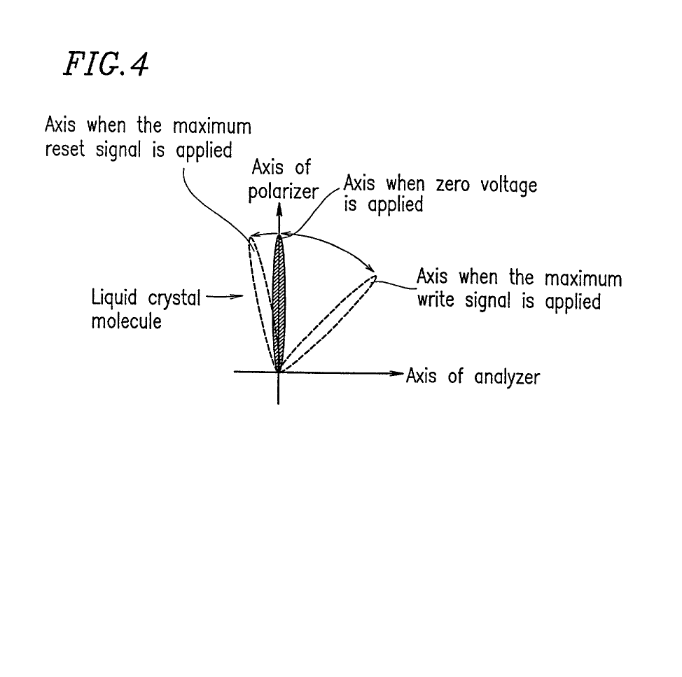

This is realized by arranging the polarizing plates 12a and 12b (FIG. 1) as shown in FIG. 4 with respect to the smectic liquid crystal molecules in the liquid crystal layer 12 (only one liquid crystal molecule is shown in FIG. 4). The polarizing plates 12a and 12b have their polarization axes perpendicular to each other. The polarization axis of one of the polarizing plates is matched to an alignment axis of the smectic liquid crystal molecules when no voltage is applied. Accordingly, when a write signal is applied, the smectic liquid crystal molecules are aligned so as to provide the maximum transmittance. When a reset signal is applied, the smectic liquid crystal molecules are aligned so as to provide a very small transmittance.

Since one frame includes the first frame and the second frame in this example, the sum of the transmittance obtained when the write signal is applied and the transmittance obtained when the reset signal is applied is the transmittance corresponding to the video signal applied to the pixel region.

Optical response time periods of the liquid crystal optical apparatus 100 to various signal voltages were measured using a ferroelectric liquid crystal composition exhibiting a chiral smectic C phase (SmC*) as the smectic liquid crystal material. The driving conditions were as follows:

Time period in which the gate electrode is on: 34 μsec;

Voltage applied to the gate electrode when it is on: +15 V;

Voltage applied to the gate electrode when it is off: −7.5 V;

Write signal voltage: 0 V ≦write signal voltage ≦+12 V;

Reset signal voltage: −12 V ≦reset signal voltage ≦0 V;

Frame frequency: 60 Hz (16.67 msec./frame);

Number of scanning lines: 480 lines; and

Number of signal lines: 640 lines.

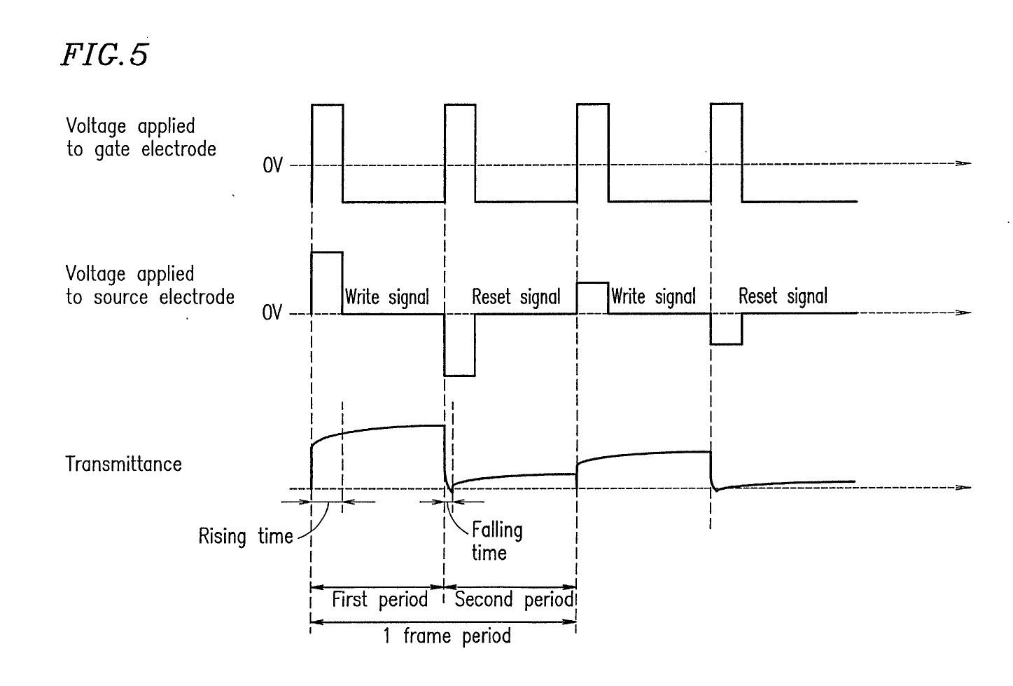

FIG. 5 is a waveform diagram illustrating waveforms of a voltage applied to the gate electrodes and a voltage applied to the source electrodes in this example, and an optical response (i.e., change in transmittance) of corresponding pixel regions in the smectic liquid crystal layer.

In this example, as shown in FIG. 5, a write signal was applied to the source electrodes in the first period of the first frame, and a reset signal was applied in the second period of the first frame. The optical response (i.e., change in transmittance) to the write signal voltage and to the reset signal voltage was measured. The optical response is represented by a rising time and a falling time as shown in Tables 1 and 2. In this specification, the “rising time” refers to a time period required for the transmittance to change from 10% of the maximum transmittance to 90% of the maximum transmittance. The “falling time” refers to a time period required for the transmittance to change from 90% of the maximum transmittance to 10% of the maximum transmittance..

Eight signal voltages were set so that 8-level gray scale display is realized. The darkest state when no voltage is applied was set as level 0. The rising time and the falling time at each level were measured in the state while the gray scale level of the frame as the target of measurement is changed with respect to the gray scale level of the previous frame or vice versa, and while the gray scale level of the frame as the target of measurement is changed with respect to the gray scale level of the succeeding frame or vice versa.

TABLE 1
Rising time (msec.)

| Gray scale | | | | | | | | |
|---|---|---|---|---|---|---|---|---|
| level of the | | | | | | | | |
| frame as the | | | | | | | | |
| target of | | | | | | | | |
| measurement | Gray scale level of the previous frame → | | | | | | | |
| ↓ | 0 | 1 | 2 | 3 | 4 | 5 | 6 | 7 |
| 0 | — | — | — | — | — | — | — | — |
| 1 | 8.3 | 8.3 | 8.3 | 2.1 | 2.3 | 2.3 | 2.7 | 2.5 |
| 2 | 4 | 4 | 3.9 | 3.9 | 3.9 | 3.9 | 3.9 | 3.9 |
| 3 | 3.1 | 3.2 | 3.4 | 3.6 | 3.6 | 3.6 | 3.6 | 3.9 |
| 4 | 2.2 | 2.3 | 2.4 | 2.5 | 2.5 | 2.6 | 2.7 | 3 |
| 5 | 1.1 | 1.2 | 1.2 | 1.2 | 1.2 | 1.2 | 1.3 | 1.4 |
| 6 | 0.91 | 0.88 | 0.9 | 0.93 | 0.93 | 0.9 | 0.85 | 0.9 |
| 7 | 0.3 | 0.3 | 0.29 | 0.29 | 0.29 | 0.31 | 0.34 | 0.35 |

TABLE 2
Falling time (msec.)

| Gray scale | | | | | | | | |
|---|---|---|---|---|---|---|---|---|
| level of the | | | | | | | | |
| frame as the | | | | | | | | |
| target of | | | | | | | | |
| measurement | Gray scale level of the succeeding frame → | | | | | | | |
| ↓ | 0 | 1 | 2 | 3 | 4 | 5 | 6 | 7 |
| 0 | — | — | — | — | — | — | — | — |
| 1 | 0.49 | 0.49 | 0.49 | 0.49 | 0.49 | 0.49 | 0.49 | 0.49 |
| 2 | 0.46 | 0.46 | 0.46 | 0.46 | 0.46 | 0.46 | 0.46 | 0.46 |
| 3 | 0.41 | 0.41 | 0.41 | 0.41 | 0.41 | 0.41 | 0.41 | 0.41 |
| 4 | 0.29 | 0.29 | 0.29 | 0.29 | 0.29 | 0.29 | 0.29 | 0.29 |
| 5 | 0.23 | 0.23 | 0.23 | 0.23 | 0.23 | 0.23 | 0.23 | 0.23 |
| 6 | 0.22 | 0.22 | 0.22 | 0.22 | 0.22 | 0.22 | 0.22 | 0.22 |
| 7 | 0.22 | 0.22 | 0.22 | 0.22 | 0.22 | 0.22 | 0.22 | 0.22 |

As shown in Tables 1 and 2, the rising time is not influenced by the gray scale level of the previous frame, or the falling time is not influenced by the gray scale level of the succeeding frame in the case of the present invention.

The reason for this is that since a write signal is applied in the first period in one frame to write information in each pixel region of the liquid crystal layer and a reset signal is applied in the second period of the same frame to delete the information, the influence of the previous and succeeding frames can be eliminated.

### COMPARATIVE EXAMPLE

For comparison, optical response time periods of a liquid crystal optical apparatus to various signal voltages were measured. The liquid crystal optical apparatus in the comparative example has the same structure as that of the liquid crystal optical apparatus 100 but is driven in a different manner.

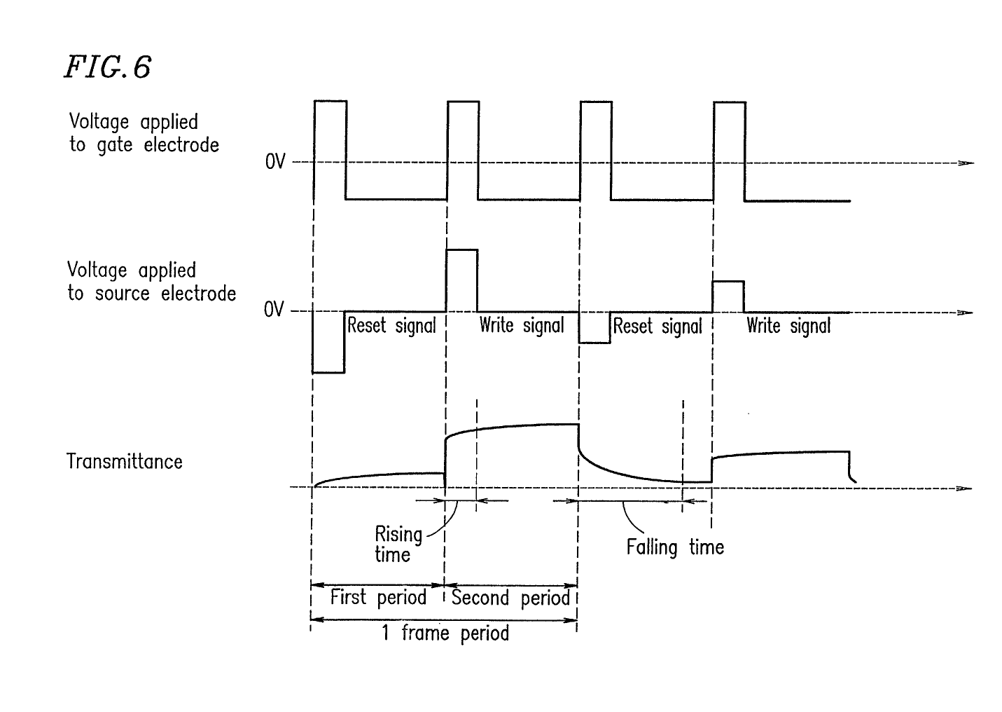

FIG. 6 is a waveform diagram illustrating waveforms of a voltage applied to gate electrodes and a voltage applied to source electrodes in the comparative example, and an optical response (i.e., change in transmittance) of corresponding pixel regions in the smectic liquid crystal layer.

As shown in FIG. 6, a reset signal was applied to the source electrodes in the first period of the first frame, and a write signal was applied in the second period of the first frame. The optical response (change in transmittance) to the write signal voltage and to the reset signal voltage was measured and is shown in Table 3 and 4 as the rising time and the falling time.

Eight signal voltages were set as in the above-described example.

TABLE 3
Rising time (msec.)

| Gray scale | | | | | | | | |
|---|---|---|---|---|---|---|---|---|
| level of the | | | | | | | | |
| frame as the | | | | | | | | |
| target of | | | | | | | | |
| measurement | Gray scale level of the previous frame → | | | | | | | |
| ↓ | 0 | 1 | 2 | 3 | 4 | 5 | 6 | 7 |
| 0 | — | — | — | — | — | — | — | — |
| 1 | 8.3 | 8.3 | 8.3 | 2.1 | 2.3 | 2.3 | 2.7 | 2.5 |
| 2 | 4 | 3.5 | 3.3 | 3.3 | 3.4 | 3.3 | 3.3 | 3.3 |
| 3 | 3.2 | 3.2 | 3.3 | 3.2 | 3.2 | 3.2 | 3.1 | 3.3 |
| 4 | 2.9 | 2.6 | 2.7 | 2.8 | 2.6 | 2.7 | 2.6 | 2.7 |
| 5 | 1.3 | 1.4 | 1.4 | 1.3 | 1.3 | 1.3 | 1.4 | 1.4 |
| 6 | 0.91 | 0.88 | 0.9 | 0.93 | 0.93 | 0.9 | 0.85 | 0.9 |
| 7 | 0.34 | 0.34 | 0.34 | 0.34 | 0.34 | 0.34 | 0.34 | 0.36 |

TABLE 4
Falling time (msec.)

| Gray scale | | | | | | | | |
|---|---|---|---|---|---|---|---|---|
| level of the | | | | | | | | |
| frame as the | | | | | | | | |
| target of | | | | | | | | |
| measurement | Gray scale level of the succeeding frame → | | | | | | | |
| ↓ | 0 | 1 | 2 | 3 | 4 | 5 | 6 | 7 |
| 0 | — | — | — | — | — | — | — | — |
| 1 | x | x | 0.46 | 0.36 | 0.3 | 0.25 | 0.19 | 0.15 |
| 2 | x | 0.7 | 0.46 | 0.36 | 0.3 | 0.25 | 0.19 | 0.15 |
| 3 | x | 0.72 | 0.49 | 0.41 | 0.39 | 0.25 | 0.21 | 0.16 |
| 4 | x | 0.68 | 0.43 | 0.32 | 0.29 | 0.25 | 0.22 | 0.17 |
| 5 | x | 0.8 | 0.57 | 0.46 | 0.34 | 0.23 | 0.21 | 0.19 |
| 6 | x | 1 | 0.74 | 0.58 | 0.56 | 0.37 | 0.22 | 0.21 |
| 7 | x | x | 2 | 1.5 | 1.2 | 0.8 | 0.55 | 0.22 |

x: Not measurable due to insufficient resetting (Optical response does not reach 10%)

As shown in Tables 3 and 4, the falling time at each gray scale level is significantly influenced by the succeeding (i.e., second) frame. Especially when the gray scale level in the second frame is low, the falling time is significantly extended or cannot be measured due to insufficient resetting. The reason for this is that when the gray scale level of the second frame is low, the reset signal voltage applied in the first period of the second frame is low, and therefore the information written by the write signal in the second period of the first frame cannot be sufficiently deleted.

In the above-described example of the present invention, a peak value of the reset signal voltage is equal to a peak value of the write signal voltage. Alternatively, the write signal voltage and the reset signal voltage may be set so that the peak value of the reset signal voltage is different from the peak value of the write signal voltage, and the product of the peak value of the write signal voltage and the application period of the write signal voltage is substantially equal to the product of the peak value of the reset signal voltage and the application period of the reset signal voltage.

The present invention is effective, for example, to a liquid crystal apparatus using a smectic liquid crystal material or a liquid crystal material having spontaneous polarization.

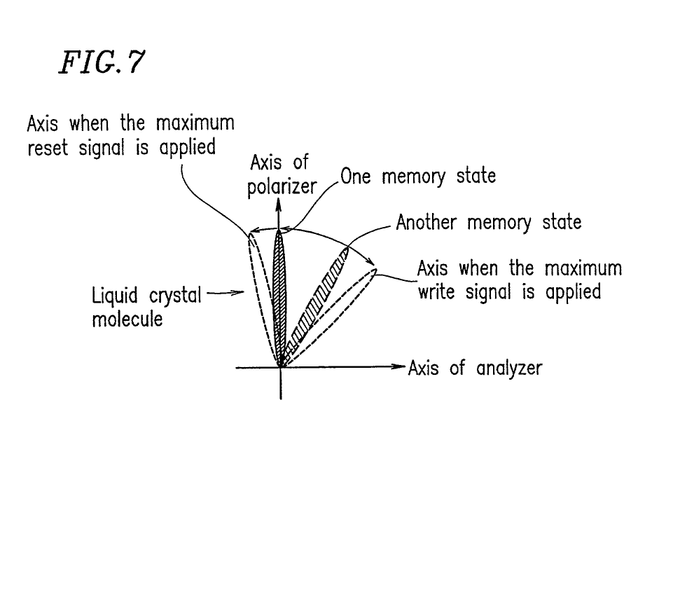

The present invention is especially effective when the smectic liquid crystal material is in a monostable state. The present invention is also applicable when the smectic liquid crystal material shows a bistable state, in which case the liquid crystal molecules and the polarizer are located in the positional relationship shown in FIG. 7. This is fundamentally the same as the positional relationship shown in FIG. 4 where the smectic liquid crystal material is in a monostable state. The waveforms of a voltage applied to the gate electrodes, a voltage applied to the source electrodes, an effective voltage applied to the pixel electrodes, and an optical response (i.e., change in transmittance) of the corresponding pixel regions in the smectic liquid crystal layer are as shown in FIG. 3.

In other words, even when the smectic liquid crystal material shows a bistable state, the liquid crystal molecules are necessarily reset to one of the two stable states by applying a reset signal, as long as the axis of the molecule when no voltage is applied matches one of the polarization axes as shown in FIG. 7, or as long as one of the two stable states is a true stable state and the other is a meta-stable state. Since the liquid crystal molecules are necessarily reset to one of the two stable states, the other state is not used for dark display. Therefore, the present invention is applicable to both the monostable state and the bistable state of the smectic liquid crystal material and provides the same effect.

The present invention is especially effective for the monostable state of the smectic liquid crystal material, and therefore is especially effective for a liquid crystal optical apparatus of an active matrix driving system. The present invention is also applicable to the bistable state of the smectic liquid crystal material, and therefore is applicable to a liquid crystal optical apparatus of a duty driving system.

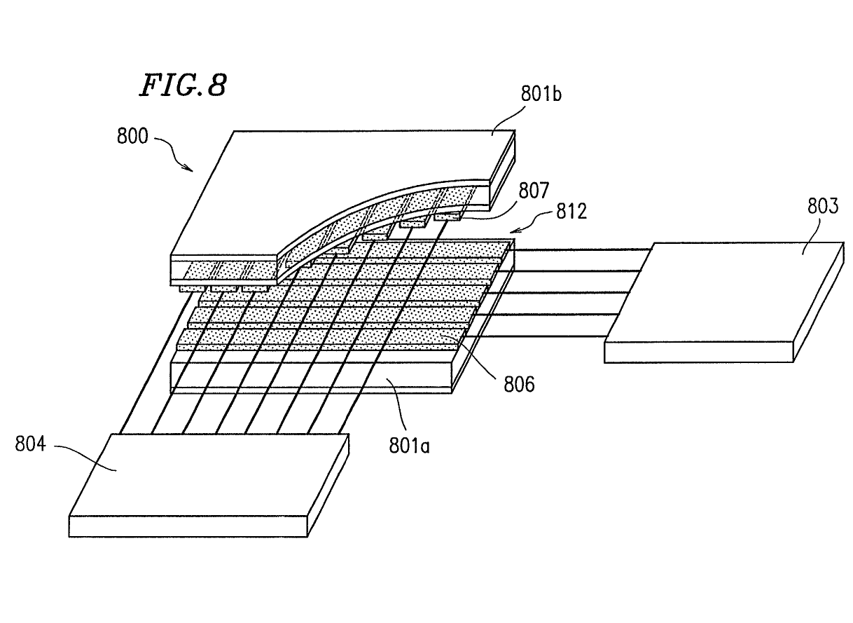

FIG. 8 is a partially cut-away isometric view of a liquid crystal optical apparatus 800 of a duty driving system according to one example of the present invention.

The liquid crystal optical apparatus 800 includes a pair of substrates 801a and 801b, and a liquid crystal layer 812 formed of a liquid crystal material and interposed between the substrates 801a and 801b. The alignment state of liquid crystal molecules of the liquid crystal material is controlled by n gate electrodes 807 provided on the substrate 801b and m source electrodes 806 provided on the substrate 801a. The source electrodes 806 are driven by a source driver 803, and the gate electrodes 807 are driven by a gate driver 804. Pixel regions are formed in the liquid crystal layer 812, at positions corresponding to intersections of the gate electrodes 807 and the source electrodes 806.

In the case of the duty driving system, the signals are applied as described below. In this system of driving also, one frame includes a first period and a second period; i.e., one frame is the period from the start of scanning of the first period until the end of the scanning of the second period.

During a time period tl (line address time period) of a first period of a first frame, a gate signal for writing is applied to a first line gate electrode 807. In synchronization therewith, a write signal corresponding to a video signal is applied to the corresponding signal electrodes 806. During time period t2 following time period tl of the first period of the first frame, a gate signal for writing is applied to a second line gate electrode 807. In synchronization therewith, a write signal corresponding to a video signal is applied to the corresponding signal electrodes 806. In the same manner, gate signals for writing are sequentially applied to the gate electrodes of the rest of the lines, and write signals are applied to the corresponding signal electrodes.

After the signal is applied to all the gate electrodes, during time period tl (line address time period) of a second period of the first frame, a gate signal for resetting is applied to the first line gate electrode 807. In synchronization therewith, a reset signal is applied to the corresponding signal electrodes 806. During time period t2 following time period tl of the second period of the first frame, a gate signal for resetting is applied to the second line gate electrode 807. In synchronization therewith, a reset signal is applied to the corresponding signal electrodes 806. In the same manner, gate signals for resetting are sequentially applied to the gate electrodes of the following lines, and reset signals are applied to the corresponding signal electrodes.

The above-described duty driving is preferably applied especially in the case where the smectic liquid crystal material shows a bistable state.

As described above, the active matrix driving system requires a signal only for turning off a gate, whereas the duty driving system requires both a gate signal for writing and a gate signal for resetting. The gate signal for writing and the gate signal for resetting may have voltages having the same peak value and opposite polarities.

The active driving system can maintain the applied voltage using the charges accumulated in the storage capacitance, whereas the duty driving system applies a write signal and a reset signal only during the line address time period.

In the above description, the present invention is applied to a liquid crystal display apparatus. As is clear to those skilled in the art, the present invention is also applicable to liquid crystal optical apparatuses including, for example, optical shutters for a laser printer heads and optical modulation devices.

As described above, when display is performed using a liquid crystal material, in which the aligning direction of the liquid crystal molecules varies in accordance with the applied voltage (for example, a smectic liquid crystal material), information needs to be written after resetting the previous display state, i.e., the alignment state of the liquid crystal molecules. When the information written in one frame is reset by applying a reset signal in the next frame, there may be an undesirable case where the information cannot be sufficiently reset due to the difference between the signal levels in the two frames.

According to the present invention, a write signal is applied in a first period of one frame and then a reset signal is applied in a second period of the same frame. Therefore, the information written in one frame is sufficiently deleted in the same frame regardless of the voltage level of the signals of the previous frame.

In the embodiment in which the reset signal has a polarity opposite to a polarity of the write signal, the alignment state of the liquid crystal molecules can be reset quickly.

In the embodiment in which the reset signal has a peak value which is substantially equal to a peak value of the write signal, the positive and negative charges can be maintained well-balanced. Therefore, the phenomenon that a part of the previous image remains in the next image, which is caused by the localization of impurity ions, is alleviated. The deterioration in the display quality such as a switching defect is prevented.

In the embodiment in which a product of a peak value of the write signal and an application period of the write signal is substantially equal to a product of a peak value of the reset signal and an application period of the reset signal, the positive and negative charges can be maintained better balanced. Therefore, the phenomenon that a part of the previous image remains in the next image, which is caused by the localization of impurity ions, is alleviated. The deterioration in the display quality such as a switching defect is more efficiently prevented. Since the application period of the write signal does not need to be equal to the application period of the reset signal, the non-display period is shortened, which realizes high luminance display.

In the embodiment in which the liquid crystal material has spontaneous polarization or is a smectic liquid crystal material, the aligning direction of the liquid crystal molecules varies in accordance with the applied voltage. The present invention is especially effective in such a case.

In the embodiment in which the liquid crystal molecules are aligned so as to correspond to a darkest state when no voltage is applied to the liquid crystal layer, there is no light leakage in the darkest state. Light leaks slightly in the reset state, but the luminance in the bright state is improved by setting each of a plurality of gray scale voltage levels in consideration of the leakage. By contrast, if the liquid crystal molecules are aligned so as to correspond to the darkest state when a reset signal is applied, the alignment direction in the reset state is significantly offset from the alignment direction when no voltage is applied. As a result, a significant amount of light leaks and thus the display quality is deteriorated. This is avoided by aligning the liquid crystal molecules so as to correspond to the darkest state when no voltage is applied to the liquid crystal layer as described above.

It is preferable that the liquid crystal material has liquid crystal molecules having one stable state when no voltage is applied to the liquid crystal layer; and when a voltage is applied to the liquid crystal layer, there is a change from the stable state to another state in accordance with a polarity and a value of the voltage. In such an embodiment, the switching speed when a reset signal is applied is improved due to the anchoring effect of the one stable state.

In the embodiment in which the liquid crystal material has a bistable state, the liquid crystal molecules need to be aligned in one of the two stable states when no voltage is applied, in order to provide uniform display. This requires a reset signal. The manner of applying a write signal and a reset signal according to the present invention is effective in this case.

In the embodiment in which a write signal and a reset signal are applied by active element, the applied voltage can be maintained for a certain period of time. Therefore, the write signal and the reset signal can be applied to the pixel electrodes stably for a sufficient period of time with no possibility of crosstalk. Thus, high quality full-color display is provided.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A liquid crystal optical apparatus, comprising:
a pair of substrates;
a liquid crystal layer provided between the pair of substrates and formed of a liquid crystal material in which an aligning direction of liquid crystal molecules changes in accordance with a voltage applied thereto;
a plurality of first electrodes provided on one of the pair of substrates; and
at least one second electrode provided on the other of the pair of substrates, wherein:
a frame period for applying a signal to the liquid crystal layer includes:
a first period in which a voltage is applied to the at least one second electrode, and a write signal for writing information to the liquid crystal layer is applied to one of the plurality of first electrodes, and
a second period in which a voltage is applied to the at least one second electrode, and a reset signal for deleting the information written in the liquid crystal layer in the first period is applied to the one of the plurality of first electrodes.

2. A liquid crystal optical apparatus according to claim 1, wherein a voltage of the reset signal has a polarity which is opposite to a polarity of a voltage of the write signal.

3. A liquid crystal optical apparatus according to claim 1, wherein the reset signal has a peak value which is substantially equal to a peak value of the write signal.

4. A liquid crystal optical apparatus according to claim 1, wherein a product of a peak value of the write signal and an application period of the write signal is substantially equal to a product of a peak value of the reset signal and an application period of the reset signal.

5. A liquid crystal optical apparatus according to claim 1, wherein the liquid crystal material having spontaneous polarization.

6. A liquid crystal optical apparatus according to claim 1, wherein the liquid crystal material is a smectic liquid crystal material.

7. A liquid crystal optical apparatus according to claim 6, wherein when no voltage is applied to the liquid crystal layer, the liquid crystal molecules of the smectic liquid crystal material are aligned so as to provide a darkest display.

8. A liquid crystal optical apparatus according to claim 1, wherein when no voltage is applied to the liquid crystal layer, the liquid crystal molecules of the liquid crystal material are in one stable state; and when a voltage is applied to the liquid crystal layer, the liquid crystal molecules are put into another state in accordance with a polarity and a value of the voltage.

9. A liquid crystal optical apparatus according to claim 1, wherein the liquid crystal material has a bistable state.

10. A liquid crystal optical apparatus according to claim 1, wherein:
at least one of the plurality of first electrodes is a pixel electrode,
the pixel electrode is connected to an active element corresponding thereto, and
the active element is connected to a source electrode and a gate electrode which substantially cross each other, and the active element is provided in the vicinity of an intersection of the source electrode and the gate electrode.
